(19) United States
(12) Patent Application Publication
(10) Pub. No.: US 2024/0144584 A1
(43) Pub. Date: May 2, 2024

(54) METHOD AND DEVICE WITH MODEL FOR 3D SCENE GENERATION

(71) Applicants: Samsung Electronics Co., Ltd., Suwon-si (KR); The Board of Trustees of the Leland Stanford Junior University, Stanford, CA (US)

(72) Inventors: Minjung SON, Suwon-si (KR); Jeong Joon PARK, Mountain View, CA (US); Gordon WETZSTEIN, Palo Alto, CA (US)

(73) Assignees: Samsung Electronics Co., Ltd., Suwon-si (KR); The Board of Trustees of the Leland Stanford Junior University, Stanford, CA (US)

(21) Appl. No.: 18/357,400

(22) Filed: Jul. 24, 2023

(30) Foreign Application Priority Data
Oct. 17, 2022 (US) 63416722
Dec. 27, 2022 (KR) 10-2022-0185836

(51) Int. Cl. G06T 15/20; G06T 17/20

(52) U.S. Cl. CPC G06T 15/20; G06T 17/20

(57) ABSTRACT

A method of training a neural network model to generate a three-dimensional (3D) model of a scene includes: generating the 3D model based on a latent code; based on the 3D model, sampling a camera view including a camera position and a camera angle corresponding to the 3D model of the scene; generating a two-dimensional (2D) image based on the 3D model and the sampled camera view; and training the neural network model to, using the 3D model, generate a scene corresponding to the sampled camera view based on the generated 2D image and a real 2D image.

### CROSS-REFERENCE TO RELATED APPLICATIONS

This application claims the benefit under 35 U.S.C. § 119(e) of U.S. Provisional Application No. 63/416,722 filed on Oct. 17, 2022, in the U.S. Patent and Trademark Office, and claims the benefit under 35 USC § 119(a) of Korean Patent Application No. 10-2022-0185836 filed on Dec. 27, 2022, in the Korean Intellectual Property Office, the entire disclosures, all of which, are incorporated herein by reference for all purposes.

### BACKGROUND

### 1. Field

The following description relates to a method of training a neural network model to generate a scene of a three-dimensional (3D) model, and a method and device for generating a scene of a 3D model.

### 2. Description of Related Art

A three-dimensional (3D) model that generates a scene may be useful in enabling ways of controlling images, in addition, such a model may acquire physically more accurate information and generate an image of the scene from arbitrary viewpoints. However, while generating a two-dimensional (2D) image is accessible because anyone can obtain a 2D image simply by capturing the image with a camera, generating a 3D model of a specific scene is plainly more involved. For example, reconstructing a 3D image using a neural network model may require accurate information about a camera pose with which an input image is captured. In addition, when there is a dynamic portion in a 3D scene, such as, for example, a moving object and/or a change in appearance, it may not be easy to estimate a camera pose and reconstruct a 3D image.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of training a neural network model to generate a three-dimensional (3D) model of a scene includes: generating the 3D model based on a latent code; based on the 3D model, sampling a camera view including a camera position and a camera angle corresponding to the 3D model of the scene; generating a two-dimensional (2D) image based on the 3D model and the sampled camera view; and training the neural network model to, using the 3D model, generate a scene corresponding to the sampled camera view based on the generated 2D image and a real 2D image.

The sampling of the camera view may include: sampling the camera view using a camera pose or a camera direction randomly determined based on a specific camera view distribution corresponding to the 3D model.

The sampling of the camera view using the randomly determined camera pose or camera direction may include: determining the camera pose by a specific camera view distribution at a center of the 3D model; or determining the camera direction by a random azimuth angle and by an altitude angle determined according to the specific distribution with respect to a horizontal plane.

The sampling of the camera view using the randomly determined camera pose and camera direction may include: determining the camera pose by a specific camera view distribution based on a position separated a predetermined distance from a center of a specific object included in the 3D model; or determining the camera direction by the specific camera view distribution in a direction toward the center of the specific object.

The sampling of the camera view may include: selecting the camera view based on determining whether the sampled camera view is inside an object included in the 3D model.

The specific camera-view distribution includes either a Gaussian distribution or a uniform distribution.

The sampling of the camera view may include: initially sampling, for a predetermined number of times, a fixed camera view that is based on a fixed camera pose corresponding to the 3D model; and for each training iteration after a lapse of a predetermined number of times, sampling the camera view using both the fixed camera view and a random camera view that is based on a camera pose randomly determined based on a specific camera view distribution corresponding to the 3D model.

The sampling of the camera view using both the fixed camera view and the random camera view may include either: alternately sampling the fixed camera view and the random camera view; or sampling the camera view while gradually expanding a range of the camera view from the fixed camera view to the random camera view.

The generating of the 2D image may include generating first patches including a portion of the 2D image corresponding to the 3D model according to the camera view, and the training of the neural network model may include training a discriminator of the neural network model to discriminate between the generated 2D image and the real 2D image based on a degree of discrimination between the first patches and second patches including respective portions of the real 2D image.

The method may further include receiving a camera view corresponding to the real 2D image, and the sampling of the camera view may include sampling the camera view by randomly perturbing at least one of a camera position or a camera direction according to the camera view corresponding to the real 2D image.

The sampling of the camera view may include: initially sampling, a predetermined number of times, a fixed camera view that is based on a fixed camera pose corresponding to the 3D model; and for each training iteration after a lapse of a predetermined number of times, sampling the camera view using both the fixed camera view and the perturbed camera view corresponding to the real 2D image.

The training of the neural network model may include: calculating a first loss based on a degree of discrimination between the generated 2D image and the real 2D image; calculating a second loss based on a degree of similarity between the camera view corresponding to the real 2D image and the perturbed camera view; and training the neural network model to generate a scene of the 3D model corresponding to the perturbed camera view based on the first loss and/or the second loss.

The training of the neural network model may include: training a generator of the neural network model to generate a scene corresponding to the sampled camera view, using a third loss that is based on a degree of similarity between the generated 2D image and the real 2D image; and training a discriminator of the neural network model to discriminate between the generated 2D image and the real 2D image, using a first loss that is based on a degree of discrimination between the generated 2D image and the real 2D image.

The scene of the 3D model may include at least one of a still image or a moving image.

In one general aspect, a method of generating an image of a three-dimensional (3D) model includes: receiving images of a 3D scene respectively corresponding to camera views in a physical space; generating a 3D model of the specific space based on the images of the 3D scene; obtaining a coordinate system for the 3D model; receiving a target camera view of an image to be generated of the physical space; and generating the image of the physical space using the 3D model based on the target camera view and the coordinate system.

The obtaining the coordinate system may include: generating a 3D model corresponding to an initial camera view in the specific space; and setting the coordinate system using the initial camera view, the 3D scenes, and the 3D model corresponding to the initial camera view.

The setting of the coordinate system may include setting the coordinate system based on at least one criterion among: a coordinate system input by the user, a specific image among the 3D scenes, a floorplan portion of the specific space, a specific object included in the specific space, and bilateral symmetry of the specific space.

18The setting of the coordinate system may further include defining a camera transform matrix that sets the coordinate system according to the at least one criterion.

A non-transitory computer-readable storage medium may store instructions for causing a processor to perform any of the methods.

In one general aspect, a device includes: memory storing images of a three-dimensional (3D) scene respectively corresponding to camera views in a physical space and storing a target camera view for an image of the physical space to be generated; and a processor configured to generate a 3D model of the physical space based on the images of the 3D scene, perform a process of obtaining a coordinate system for the 3D model, and generate an image corresponding to the target camera view using the 3D model based on the target camera view and the coordinate system.

Other features and aspects will be apparent from the following detailed description, the drawings, and the claims.

### BRIEF DESCRIPTION OF THE DRAWINGS

FIG. 1 illustrates an example structure of a neural network model according to one or more example embodiments.

FIG. 2 illustrates an example method of training a neural network model according to one or more example embodiments.

FIG. 3 illustrates an example training structure and operation of a neural network model according to one or more example embodiments.

FIGS. 4A and 4B illustrate an example of training a generator and a discriminator included in a neural network model, and an example of operating a renderer included in the neural network model according to one or more example embodiments.

FIG. 5 illustrates an example two-dimensional (2D) image rendered by a neural network model and an example three-dimensional (3D) image generated by the neural network model according to one or more example embodiments.

FIG. 6 illustrates an example training structure and operation of a neural network model according to one or more example embodiments.

FIGS. 7A, 7B, 7C, and 7D illustrate example 2D images obtained by rendering a 3D scene generated based on a fixed camera view of a neural network model according to one or more example embodiments.

FIG. 8 illustrates an example training structure and operation of a neural network model according to one or more example embodiments.

FIG. 9 illustrates example 2D images generated based on a fixed camera view of a neural network model according to one or more example embodiments.

FIG. 10 illustrates an example method of generating a scene of a 3D model according to one or more example embodiments.

FIG. 11 illustrates an example inference structure and operation of a neural network model included in a device for generating a scene of a 3D model according to one or more example embodiments.

FIG. 12 illustrates an example device for generating a scene of a 3D model according to one or more example embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

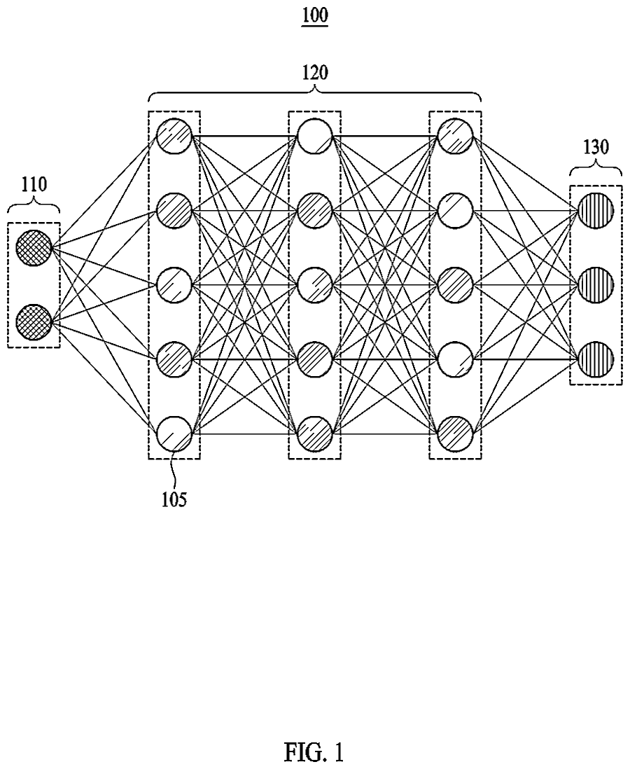

FIG. 1 illustrates an example structure of a neural network model according to one or more example embodiments. Referring to FIG. 1, a neural network model may include a neural network 100, for example.

The neural network 100 may be an example of a deep neural network (DNN). A DNN may be or may include, for example, a fully connected network, a deep convolutional neural network (DCNN), a recurrent neural network (RNN), and a generative adversarial network (GAN). Examples of the neural network 100 including a GAN model are described herein. According to an example embodiment, an electronic device may train one or more neural network models and perform inference (e.g., generating a three-dimensional (3D) model of a scene) using the trained neural network models. A method of training a neural network model is described in detail below.

The neural network 100 may perform various operations by mapping input data and output data which are in a nonlinear relationship based on deep learning. The neural network 100 may map the input data and the output data through supervised or unsupervised machine learning. Unsupervised machine learning may include, for example, reinforcement learning that learns through trial and error.

Referring to FIG. 1, the neural network 100 may include an input layer 110, a hidden layer 120, and an output layer 130. The input layer 110, the hidden layer 120, and the output layer 130 may each include a respective plurality of nodes 105.

Although the neural network 100 as illustrated in FIG. 1 as includes three hidden layers 120 for the convenience of description, there may be varying numbers of hidden layers 120. In addition, although the neural network 100 is illustrated in FIG. 1 as including the separate input layer 110 for receiving input data, input data may be input directly to a hidden layer 120 without the input layer 110. In the neural network 100, nodes of layers, excluding the output layer 130, may be connected to artificial nodes of a subsequent layer via links for transmitting node output signals. The number of links may correspond to the number of artificial nodes included in the subsequent layer.

Each of nodes included in the hidden layer 120 may receive an output of an activation function associated with weighted inputs of nodes included in a previous layer. The weighted inputs may be obtained by multiplying a weight to inputs of the nodes included in the previous layer. The weight may also be referred to as a parameter of the neural network 100. The activation function may include, for example, a sigmoid, a hyperbolic tangent (tanh), or a rectified linear unit (ReLU), but examples are not limited thereto. By the activation function, nonlinearity may be formed in the neural network 100. To each of the nodes included in the output layer 130, weighted inputs of artificial nodes included in a previous layer may be input.

When the neural network 100 has sufficiently great width and depth, the neural network 100 may have a sufficiently large capacity to implement an arbitrary function.

Although the neural network 100 is described above as an example of a neural network model, the neural network model is not limited to the neural network 100 and may be implemented in various structures.

As is described in more detail below, the electronic device may train a neural network model including a generator, a discriminator, and/or a renderer. GAN models including mainly a generator and a discriminator are described herein as examples of the neural network model. The electronic device may train the generator using the trained discriminator or perform an inference operation (e.g., generation) using the discriminator and/or the generator. A neural network model training method and structure is described below with reference to the accompanying drawings.

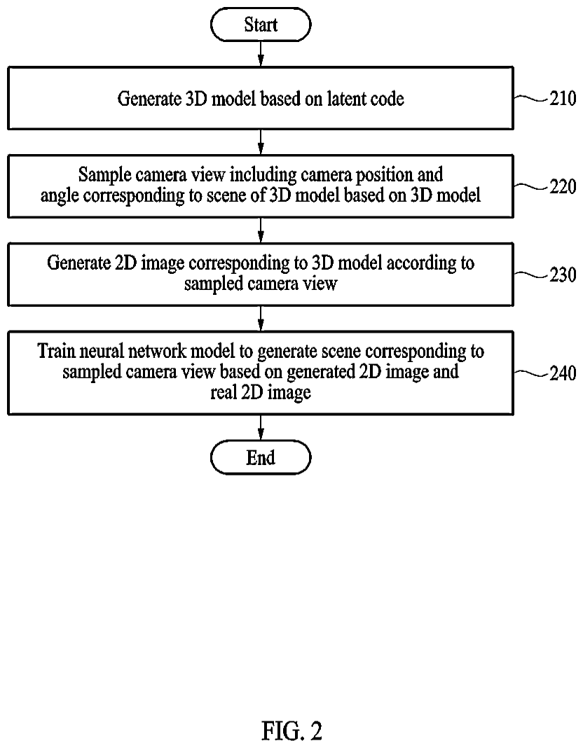

FIG. 2 illustrates an example method of training a neural network model according to one or more example embodiments.

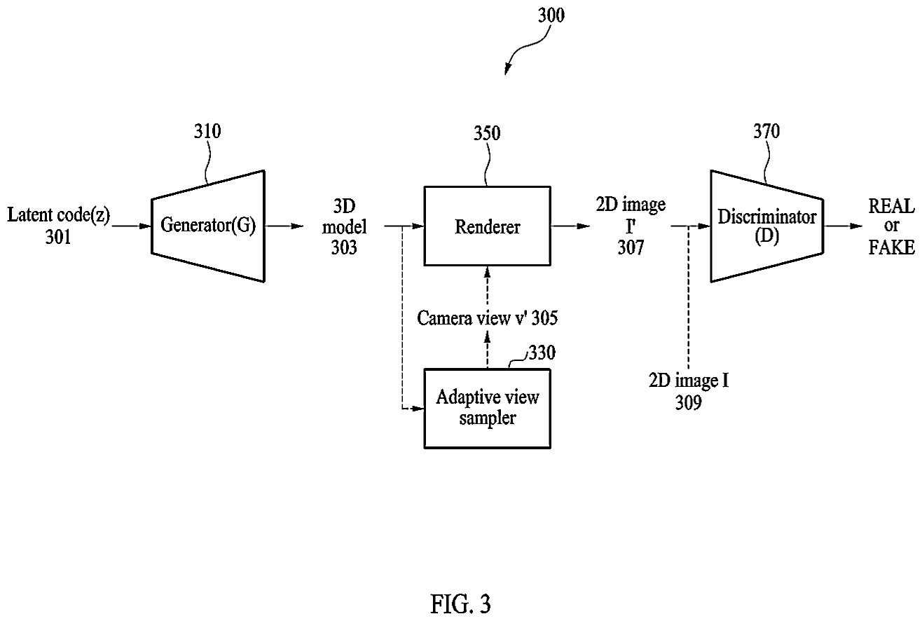

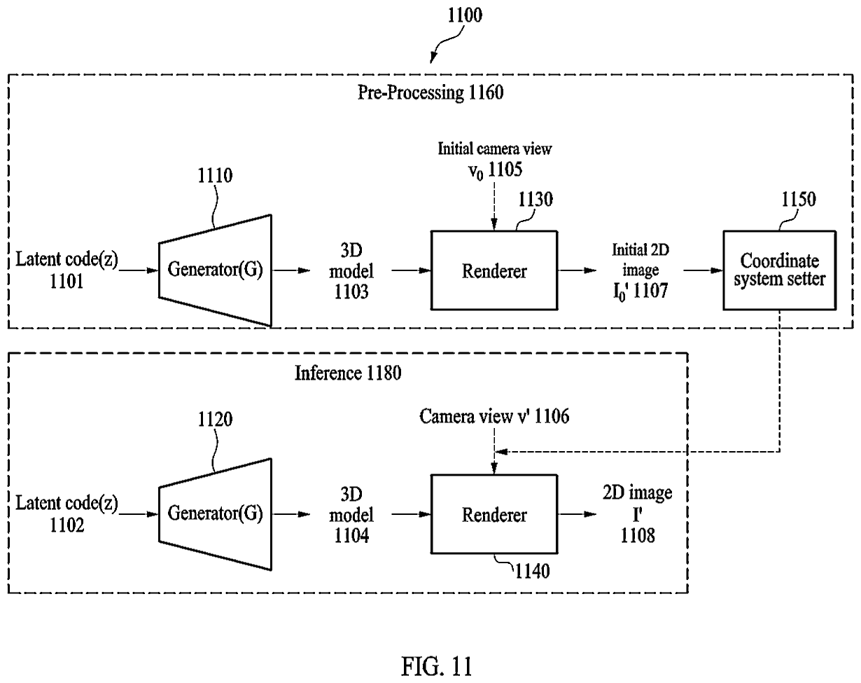

Referring to FIG. 2, an electronic device according to an example embodiment (e.g., the electronic device 1200 of FIG. 11) may train a neural network model through operations 210 to 240. The neural network model may include, for example, a generator 310, an adaptive view sampler 330, a renderer 350, and a discriminator 370, as illustrated in FIG. 3, but embodiments are not limited thereto.

In operation 210, the electronic device may generate a 3D model based on a latent code. The latent code may refer to a vector in a latent space that may well-describe data with reduced dimensionality and may also be referred to as a “latent vector,” a “noise vector,” or a “random code.” The electronic device may generate a scene of the 3D model using the 3D model generated by the generator 310. A scene of the 3D model described herein may be a 3D structure(s) that may be generated by the 3D model. A scene of the 3D model may be independent of a camera view (i.e., is not a view of the scene with respect to any particular viewpoint). The electronic device may generate a two-dimensional (2D) image viewed from a specific camera view by rendering the 3D model based on the specific camera view (here, “camera” refers to a “virtual camera”).

In operation 220, the electronic device may sample the 3D model (generated in operation 210) according to a camera view including a camera position and a camera angle corresponding to a scene of the 3D model. For example, the electronic device may adaptively sample the camera view according to various situations by the adaptive view sampler 330. The adaptive view sampler 330 may adaptively sample the camera view according to whether there is a given camera view and/or how to determine a camera pose.

For example, the electronic device may generate varied scenes by varying sampling by varying a sampling camera pose, i.e., a view, during training (or learning).

The electronic device may sample the camera view by randomly setting a camera pose (which includes a camera direction) in the 3D model. The electronic device may sample the camera view using the randomly set camera pose based on a specific distribution corresponding to the 3D model. A neural network model structure and operation that enables the electronic device to sample a camera view by randomly setting a camera pose in a 3D model is described with reference to FIG. 3.

In addition, the electronic device may prevent the 3D model generated at an early stage of training from converging on a specific scene, in order allow generating maximally varied scenes of the 3D model, rather than only a converged-on specific scene. The electronic device may initially set camera poses uniformly and perform training to obtain a maximal variation in a 2D image based on a camera view according to the fixed camera poses, and may then gradually vary the camera pose to generate a 3D model for all scenes. The electronic device may train the neural network model to generate a scene with a greater variation by focusing on reconstructing a local distribution using, for example, patch GANs.

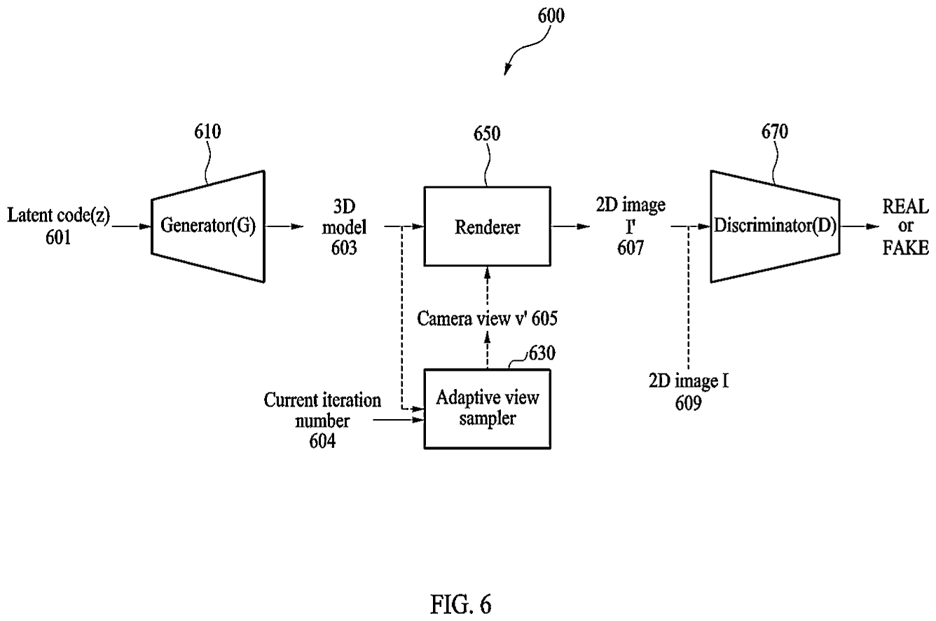

A neural network model training structure and operation that prevents a model generated at an early stage of training from converging on a specific scene and gradually varies a camera pose to sample a camera view is described with reference to FIG. 6.

In addition, when an accurate camera pose(s) for input images is given, the electronic device may sample the camera view by giving a perturbation (or simply “perturbing” herein) the given camera pose and/or a camera direction, and may thereby train the neural network model to cover all/most scenes of the 3D model while following a distribution according to the given camera pose. The electronic device may train the neural network model using a loss (e.g., a pixel similarity loss) that is based on a degree of similarity between the given camera pose and the sampled camera view, along with a loss (e.g., an adversarial loss) that is based on a degree of discrimination between a 2D image generated by the neural network model (e.g., corresponding to the sampled camera view) and a real 2D image (e.g., corresponding to the given camera pose), when necessary.

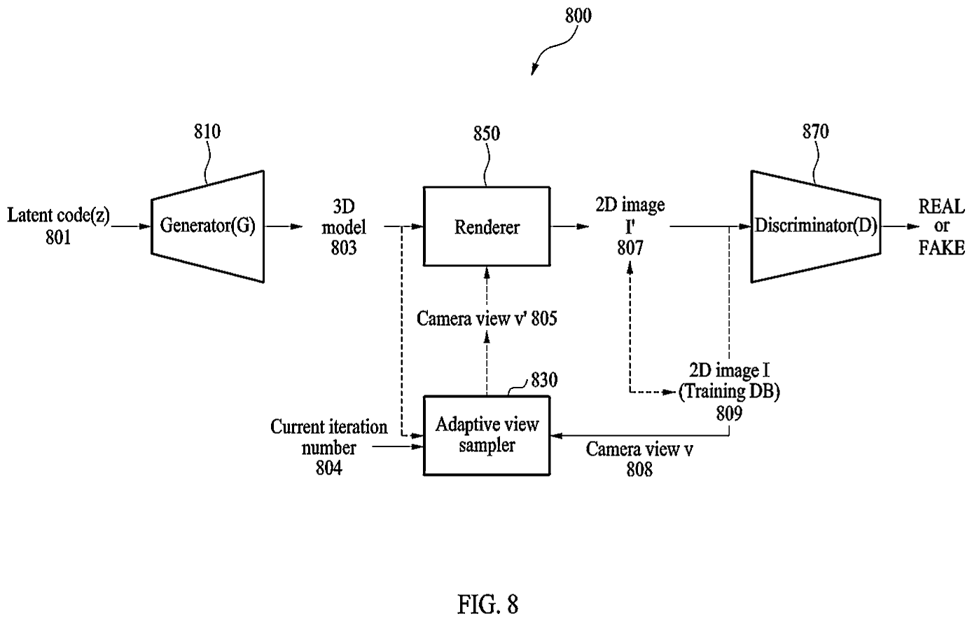

A neural network model structure and operation that enables the electronic device to sample a camera view by perturbing a given camera pose when an accurate camera pose(s) for input images is given is described with reference to FIG. 8.

In operation 230, the electronic device may generate a 2D image based on the 3D model generated in operation 210 according to the camera view sampled in operation 220. The electronic device may generate the 2D image based on the 3D model using 2D image pixels obtained through the sampled camera view. The electronic device may generate the 2D image by the renderer 350 according to the scene of the 3D model.

In operation 240, the electronic device may train the neural network model to generate a scene corresponding to the camera view sampled in operation 220, based on the 2D image generated in operation 230 and based on a real 2D image. The electronic device may train a generator, a discriminator, and/or a renderer. For example, the electronic device may train the generator of the neural network model to generate the scene corresponding to the camera view sampled in operation 220 using a third loss that is based on a degree of similarity between the 2D image generated in operation 230 and the real 2D image. The electronic device may train the discriminator of the neural network model to discriminate between the 2D image generated in operation 230 and the real 2D image using a first loss that is based on a degree of discrimination between the 2D image generated in operation 230 and the real 2D image. In addition, the electronic device may train the renderer of the neural network model using a loss that is based on a degree of similarity between the 2D image generated in operation 230 and the real 2D image of the scene, where the 2D image is stored in a training database (DB) and corresponds to the camera view. The electronic device may train the renderer to render the 2D image corresponding to the scene of the 3D model to be similar to the real 2D image.

Alternatively, the renderer may be an algorithm or operation that does not require training or learning. For example, a differentiable renderer may be capable of backpropagation and transfer of a loss to a network in front of the renderer to train the network in front of the renderer, and thus the differentiable renderer itself may not be trainable per se. The differentiable renderer may also correspond to a specific operation or algorithm. The electronic device may reconstruct a desired scene in various ways by the neural network model trained through the foregoing process, even in an environment where a corresponding camera view is not previously provided, e.g., an environment where an accurate camera view is difficult to know, or an environment where a pixel similarity loss is difficult to use due to the presence of a dynamic portion (e.g., a moving object, and/or a changing appearance, etc.) in a scene of the 3D model.

FIG. 3 illustrates an example training structure and operation of a neural network model according to one or more example embodiments. Referring to FIG. 3, a neural network model 300 according to an embodiment may include a generator (G) 310, an adaptive view sampler 330, a renderer 350, and a discriminator (D) 370.

The generator 310 may generate a 3D model 303 having various 3D structures from source data. The 3D model 303 may also be referred to as a 3D scene representation. The source data may be, for example, a source image, or, data (e.g., a latent code Z 301) sampled in a source latent space. The generator 310 may also be interpreted as a function for generating a scene of a 3D model from a latent code.

The adaptive view sampler 330 may sample a camera view (which includes a camera position and angle corresponding to the 3D model 303) based on the 3D model 303 generated by the generator 310.

For example, the neural network model 300 may sample the camera view maximally variously by a method of varying a sampling camera pose, i.e., a view, during training.

The adaptive view sampler 330 may sample the camera view by randomly setting a camera pose according to a distribution determined in the 3D model 303. Such a sampling method may be referred to as random view sampling. The random view sampling method may be as follows.

In a case of a scene of a 3D model, a common view is a view of looking around from inside a space corresponding to the 3D model. The adaptive view sampler 330 may determine the camera pose based on a specific distribution (e.g., a Gaussian distribution) at a center or a center point of the 3D model 303. The adaptive view sampler 330 may determine the camera direction based on a random azimuth and altitude angle according to a specific distribution (e.g., a Gaussian distribution) determined based on a horizontal plane (0 degree (°)). The Gaussian distribution may be, for example, a normal distribution. The Gaussian distribution may correspond to any continuous probability distribution representing a probability that a random variable has a specific value.

For example, when learning images of a specific scene, for example, a room, the adaptive view sampler 330 may define camera poses by a Gaussian distribution that is based on a center of the room. In this example, the height may often move within a certain limited range, and based on this, a sigma value (corresponding to an estimation error during camera calibration) may be set to be small. The adaptive view sampler 330 may define or determine camera directions based on a uniformly distributed azimuth angle and based on and a Gaussian distribution of altitude angle defined based on a horizon. Such a distribution may provide “looking” around the entire room. The uniform distribution may be a distribution in which all probabilities are uniform in a predetermined range. For example, the uniform distribution may correspond to a distribution of continuous random variables X having the same value anywhere in intervals a and b. A probability density function in the intervals a and b may be a≤X≤b, and a probability density function f(X) in another interval may be zero (0) (i.e., f(X)=0).

Alternatively, in a case of images of a specific object, there may be many views of looking towards the specific object from far away from the specific object by a predetermined distance. When learning the images of the specific object, the adaptive view sampler 330 may determine camera poses by a specific distribution (e.g., a Gaussian distribution) that is based on positions (e.g., a hemisphere) away from a center of the specific object included in the 3D model 303 by a predetermined distance. The adaptive view sampler 330 may determine camera directions by a specific distribution (e.g., a Gaussian distribution) in a direction toward the center of the specific object included in the 3D model 303.

As noted, the adaptive view sampler 330 may sample the camera view in a random direction viewing the 3D model 303. In this case, the adaptive view sampler 330 may perform the sampling by verifying density or occupancy such that the sampled camera view does not exist inside the 3D model 303 (i.e., inside a solid portion of the 3D model 303, e.g., inside a solid object). The density or occupancy may indicate whether a corresponding 3D coordinate in the 3D model 303 is empty (space) or full (modeled object/material). A probability that the 3D coordinate is full/occupied may also be expressed as a value between 0 and 1 and may thus be referred to as a probability density.

The adaptive view sampler 330 may examine the validity of the sampled camera view such that the sampled camera view does not exist inside an object included in the 3D model 303, based on a specific distribution corresponding to the camera view. The adaptive view sampler 330 may select a camera view based on a validation result obtained by examining the validity. The adaptive view sampler 330 may determine whether the sampled camera view is valid by, for example, verifying a density of a 3D position (e.g., 3D coordinates) of a camera in the 3D model 303.

Because a to-be-sampled camera view should not be inside an object in the 3D model 303, the adaptive view sampler 330 may set the camera pose for sampling when the density of the 3D position corresponding to the to-be-sampled camera view is less than or equal to a predetermined value. The density of the 3D position being less than or equal to the predetermined value may indicate that the to-be-sampled camera view is outside an object. The adaptive view sampler 330 may sample the camera view maximally variously to increase data utilization limited to a single scene.

The renderer 350 may generate a 2D image I′ 307 by rendering the 3D model 303 generated by the generator 310. In this case, the renderer 350 may generate the 2D image I′ 307 corresponding to the 3D model 303 according to a camera view V′ 305 sampled by the adaptive view sampler 330. The renderer 350 may be a differential renderer.

The discriminator 370 may output discrimination data (e.g., REAL and FAKE indications) corresponding to similarity between (i) the 2D image I′ 307 rendered by the renderer 350 from the 3D model 303 and (ii) a real 2D image I 309. In this case, the real 2D image I 309 may be one that is stored in a training DB. The electronic device may construct the training DB from 2D images of a physical scene, and use the constructed training DB in a process of training the neural network model 300. In this case, the scene may be a single scene. 2D images may be removed from, replaced in, or added to the DB during the training of the neural network model 300, and this may not affect the progress of the training.

The discrimination data may indicate an inference of whether an image input to the discriminator 370 is a real image or a generated image. The discrimination data may include, for example, a probability map indicating a probability value that a 2D image is a real image or a probability value that a 2D image is a generated image.

The discriminator 370 may output the discrimination data for determining a degree of similarity between the 2D image I′ 307 (generated by rendering the 3D model 303) and the real 2D image I 309. The discrimination data may be used to guide the training of the generator 310.

The generator 310 may be trained based on a first loss (e.g., an adversarial loss) that is based on a degree of discrimination between the generated 2D image I′ 307 and the real 2D image I 309. The generator 310 may be trained to output the 3D model 303 that is able to generate an image similar to a real image to deceive the discriminator 370 (i.e., not allow the discrimination between real or fake).

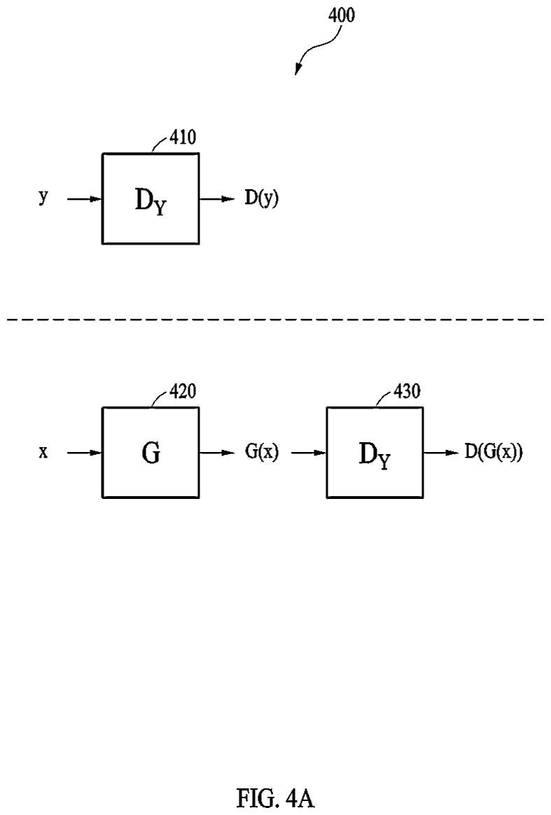

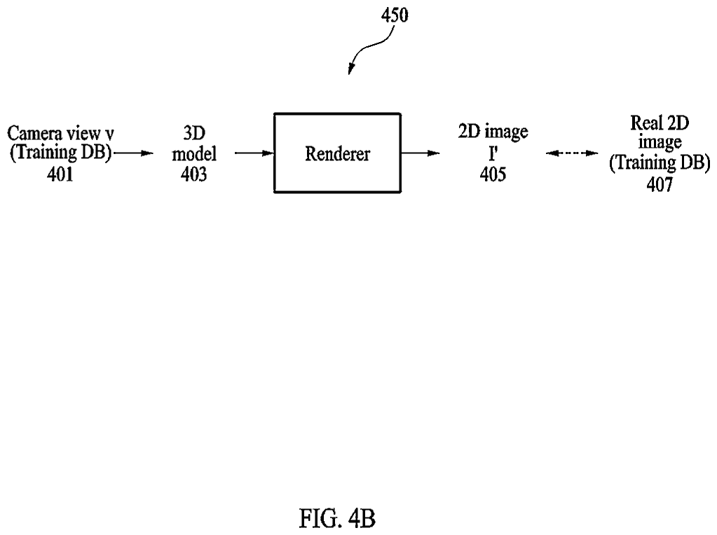

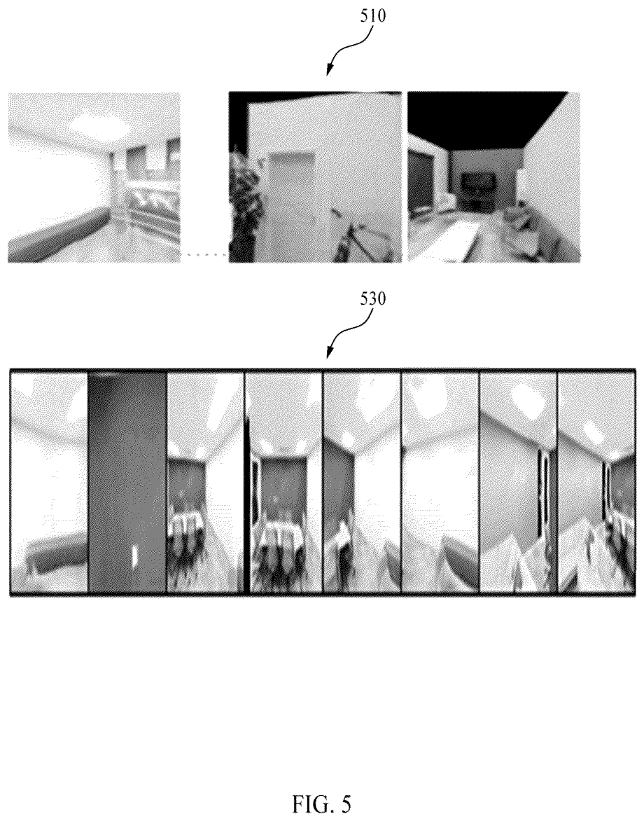

The generator 310 and the discriminator 370 may respectively correspond to, for example, a generator and a discriminator of a GAN, but examples of which are not necessarily limited thereto. A method of training the generator 310 and the discriminator 370 is described with reference to FIGS. 4A and 4B. A method of training the renderer 350 is described with reference to FIG. 5.

FIG. 4A illustrates an example of training a generator and a discriminator included in a neural network model according to one or more example embodiments. An example process of training a discriminator 410 using a real 2D image is illustrated in the upper part of FIG. 4A, and an example process of training a generator G 420 and a discriminator 430 using a generated 2D image is illustrated in the lower part of FIG. 4A. The generator G 420 and the discriminator 410 or 430 of the neural network model may be trained by solving a minmax problem using an objective function V(D, G), as expressed by Equation 1.

$${min}_{G} {max}_{D} V ( D , G ) = {𝔼}_{x ∼ P data ( x )} [ log D ( x ) ] + {𝔼}_{z ∼ Pz ( z )} [ log ( 1 - D ( G ( z ) ) ) ] \qquad Equation 1$$

On the discriminator's side, operations are as follows.

In Equation 1, x˜Pdata(x) denotes data sampled in a probability distribution of real data. For example, if there are 100 real 2D images in a training DB, x-Pdata(x) may indicate sampling one 2D image x among the 100 real 2D images.

The discriminator 430 needs to output 1 or a value close to 1 for the real 2D image and output 0 or a value close to 0 for the generated 2D image, and thus a [logD(x)] value may be expressed to be numerically maximized. The discriminator 430 may output a value between 0 and 1.

In Equation 1, z˜Pz(z) denotes data sampled from random noise or latent code z, generally using a Gaussian distribution. z may be input to generator 420. For example, the generator 420 may sample a multi-dimensional vector based on the Gaussian distribution (e.g., a normal distribution). When receiving the random multi-dimensional vector z, the generator 420 may generate a 3D model G(x). The 3D model may be rendered to be a 2D image by a renderer, and the discriminator 430 may be trained to discriminate between the real 2D image and the rendered 2D image.

On the generator's side, operations are as follows.

Since a value [symbol] _{x˜Pdata(x)}[logD(x)] (the left term of Equation 1) needs to be minimized and the generator 420 is not used to train the discriminator 430, z˜Pz(z) in Equation 1 (corresponding to a portion in which the generator 420 is not involved) may be omitted. Thus, the generator 420 may be trained such that [symbol] _{z˜Pz(z)}[log(1−D(G(z)))] is minimized in Equation 1. The generator 420 may be trained such that D(G(z)) becomes 1 (i.e., D(G(z))=1), contrary to the discriminator 430.

As described above, the neural network model may train the discriminator (e.g., the discriminators 410 and 430) such that V(D, G) is maximized and train the generator 420 such that V(D, G) is minimized.

FIG. 4B illustrates an example of operating a renderer included in a neural network model according to one or more example embodiments. A differential renderer 450 may operate as illustrated in FIG. 4B.

When various scene parameters corresponding to a 3D model 403 are input to the differentiable renderer 450, the differentiable renderer 450 may render various images corresponding to the scene parameters. The scene parameters may include, for example, rendering parameters associated with material, light, camera, and geometry, but are not necessarily limited thereto.

The differentiable renderer 450 may generate various images, such as, for example, a meta image, a red, green, blue (RGB) image, a depth image, and/or a silhouette image, according to the input scene parameters.

For example, when a camera view V 401 stored in a training DB is input to the 3D model 403, the differentiable renderer 450 may generate a 2D image I′ 405 corresponding to the camera view V 401 using the camera view V 401 and the 3D model 403.

The differentiable renderer 450 may be trained by a loss that is based on a degree of similarity between the generated 2D image I′ 405 and a real 2D image I 407 corresponding to the camera view 401 stored in the training DB in association with the real 2D image I 407.

FIG. 5 illustrates an example 2D image rendered by a neural network model and an example 3D scene generated by the neural network model according to one or more example embodiments. Referring to FIG. 5, there are rendered 2D images 510 obtained by a renderer of a neural network model by rotating a 3D model by 360° based on a learned scene, and scenes 530 of the 3D model generated according to a camera view sampled through adaptive sampling by the neural network model.

An electronic device may train the neural network model (e.g., a 3D GAN) such that it is not able to discriminate between real 2D images and 2D images generated by sampling a random camera view with respect to training input images captured from a target scene. The neural network model trained in such a way may allow a scene to be generated to finally converge on the target scene (as a whole) such that images viewed from any camera view follow a distribution of training data.

When successfully reconstructing a single scene that is estimated from the training data, a generator of the neural network model may avoid a mode collapse that may occur in 2D images from a 3D model that generates images of various structures according to views. The “mode collapse” may refer to a situation in which the generator fails to generate various arbitrary images and instead continuously generates only certain images that are similar to each other.

However, when viewed in three dimensions, the generated scene may eventually converge on a single scene, and it may be considered that mode collapse has occurred, which may show a similar result to previous reconstruction methods. However, when GAN training is used to generate various scenes, without the mode collapse, even in 3D, it may be considered that variational reconstruction is performed, unlike the previous methods.

According to an example embodiment, through the camera sampling variation described above, the characteristics of the neural network model may be applied to interpolation, extrapolation, and/or variational reconstruction, in addition to 3D model reconstruction of a scene. In terms of a 3D GAN, when mode collapse is avoided, 3D variational scenes that are similar to an input image but have various variations instead of one similar image may be generated, which may be referred to as a “variational reconstruction.” In addition, according to an example embodiment, even for a view not included in the training input, a realistic image may be generated even through the camera sampling variation described above, due to the characteristics of the GAN. In this case, it may be possible not only to generate a desirable interpolation result for a view among input views, but also to perform extrapolation that generates a somewhat realistic result even for a view that is not included between input images/views.

FIG. 6 illustrates an example of a training structure and operation of a neural network model according to one or more example embodiments. Referring to FIG. 6, a neural network model 600 according to an example embodiment may include a generator G 610, an adaptive view sampler 630, a renderer 650, and a discriminator D 670. Respective operations of the generator G 610, the adaptive view sampler 630, the renderer 650, and the discriminator D 670 are generally the same as operations of the generator 310, the adaptive view sampler 330, the renderer 350, and the discriminator D 370 described above with reference to FIG. 3; following is description of operations generally different from the operations of the neural network model 300 of FIG. 3.

The adaptive view sampler 630 may sample camera views using an alternative view sampling method or a gradual view sampling method to diversify variation in a scene, namely, by using adaptive sampling of the camera views. The method of FIGS. 3 and 6 may both reduce mode collapse information (that is, secure a sufficient number of modes) by limiting the camera views (e.g., a coarse distribution) at an early stage of training, and may then gradually expand the range of the camera views to be sampled to allow a neural network model to learn a sufficiently wide range of 3D information. Put another way, the adaptive view sampler 630 may sample a camera view for each input (multiple samples), but the sampled cameras views are identical at the earlier stage of training. After the earlier stage of training (when using an identical camera view), view sampling strategy may be changed to cover full 3D. Random sampling and fixed (identical) view sampling may be alternatively repeated during further training.

To gradually expand the range of the camera views to be sampled after the early stage of training, the neural network model 600 may inference based on a current training iteration number 604 which indicates the current number of iterations of training, in addition to inferencing on a 3D model 603 generated based on a latent code 601.

The adaptive view sampler 630 may sample a camera view V′ 605 based on the 3D model 603 and the current training iteration number 604 and transmit the sampled view to the renderer 650.

The renderer 650 may generate (or render) a 2D image I′ 607 based on the 3D model 603 according to the camera view V′ 605. The discriminator 670 may output a degree of discrimination between the generated 2D image I′ 607 and a 2D image I 609 corresponding to a single scene previously stored in a training DB. The output discrimination may be in the form of REAL (or “1”) or FAKE (or “0”), for example.

The adaptive view sampler 630 may initially sample, for a predetermined number of times at an early stage of training, according to a fixed camera pose corresponding to the 3D model 603 and/or a fixed camera view according to a camera direction. Then, for each training iteration after a predetermined number of iterations, the adaptive view sampler 630 may sample camera views by using the fixed camera pose (corresponding to the 3D model 603) followed by sampling a random camera view according to a camera pose randomly determined based on a specific camera-sampling distribution corresponding to the 3D model 603; this fixed-random alternation may be repeated.

The alternative view sampling method may generate a varied scene using a fixed camera view at an early stage of training and then, after a predetermined number of iterations (or amount of time), alternately sample the fixed camera view and a random camera view, thereby giving various perturbations to a scene of the 3D model 603 while generating the scene corresponding to an input distribution (a few or several camera views may be used, so long as a same camera view is used for a sufficient number of iterations). The adaptive view sampler 630 may alternately sample the fixed camera view and the random camera view according to the alternative view sampling method as described above. Note, a strict fixed-random alternation is not required. A fixed view may be sampled, then several random views sampled, then a fixed view sampled, and so forth.

Similarly, the gradual view sampling method may generate a varied scene of the 3D model 603 using a fixed camera view at an early stage of training and perform sampling while gradually expanding a range of a camera view from the fixed camera view to a random camera view every training iteration after a predetermined number of times elapses, thereby giving various perturbations to a scene of the 3D model 603 while generating the scene corresponding to an input distribution. The adaptive view sampler 630 may sample the camera view by gradually expanding the range of the camera view from the fixed camera view to the random view according to the gradual view sampling method as described above.

In addition, the neural network model 600 may use a patch GAN that uses a patch corresponding to a portion of an image instead of the entire image in the discriminator 670 to diversify variation in the scene. Using the patch GAN for the discriminator 670, the renderer 650 may generate first patches including a portion of a 2D image corresponding to the 3D model 603 according to the camera view. The neural network model 600 may train the discriminator 670 to discriminate between a generated 2D image and a real 2D image based on a degree of discrimination between the first patches and second patches including a portion of the real 2D image or based on a mean value of differences between the first patches and the second patches including the portion of the real 2D image.

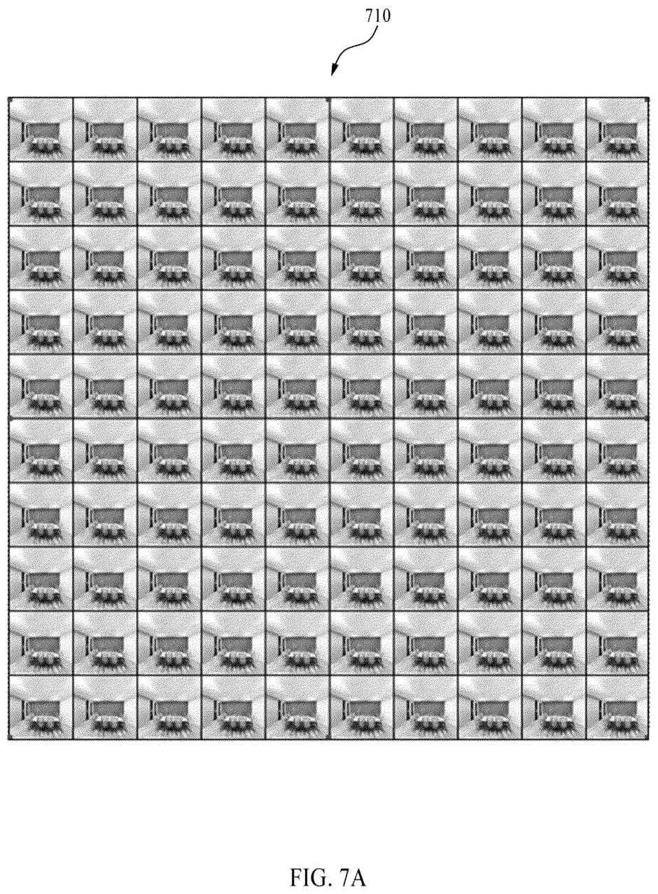

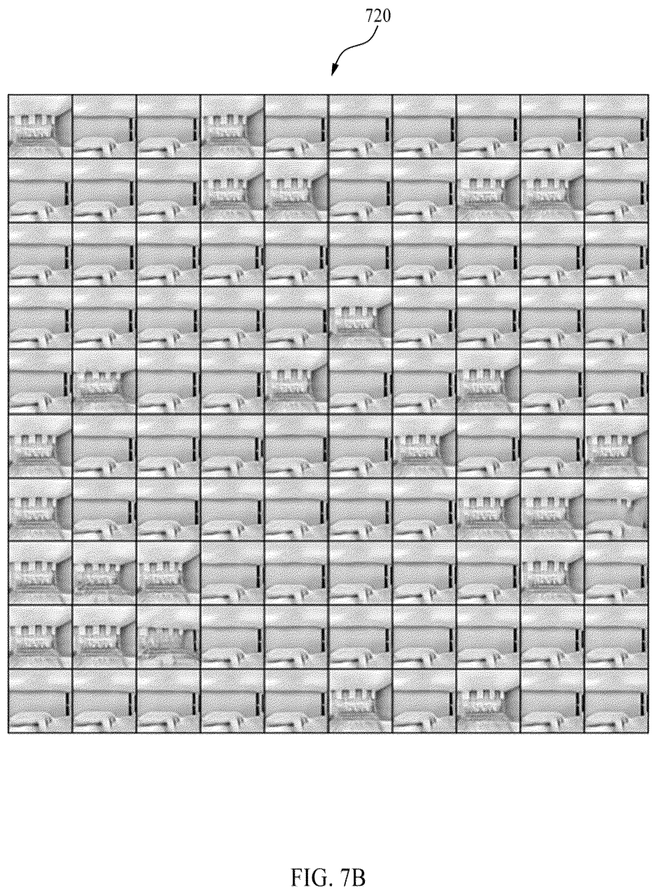

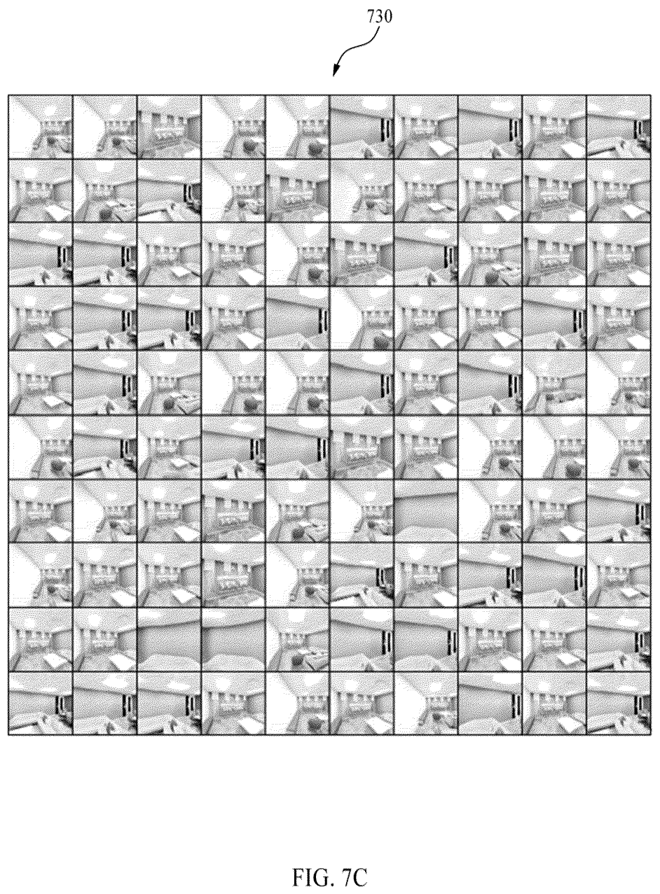

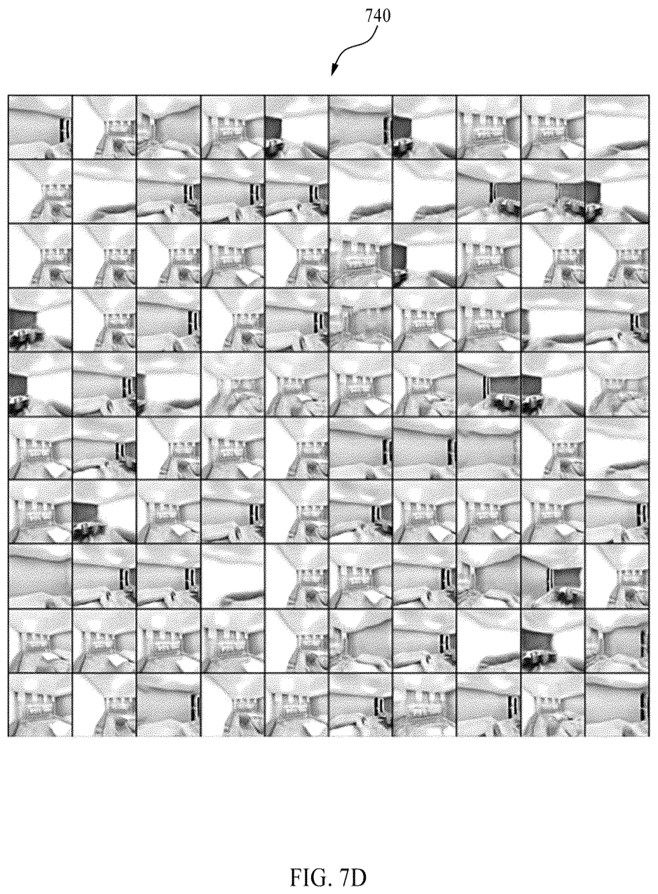

FIGS. 7A, 7B, 7C, and 7D illustrate example 2D images obtained by rendering a 3D scene generated based on a fixed camera view of a neural network model according to one or more example embodiments. FIGS. 7A, 7B, 7C, and 7D show results of rendering scenes generated using 100 latent codes according to a fixed camera view, for neural network models trained by respective sampling methods.

FIG. 7A shows a result 710 of rendering a 3D scene generated by a neural network model trained by random view sampling. FIG. 7A shows an example of undesirable mode collapse. The images in FIG. 7A are all the same (mode collapse). This may occur when the images have varying input latent codes but nonetheless are rendered using a single identical camera view. Because of the mode collapse problem, the correspondingly trained neural network model may generate a single scene without any variation, even with varying input latent codes.

FIG. 7B shows a result 720 of rendering a 3D scene generated using a neural network model trained by random view sampling after initial training with a fixed camera view.

FIG. 7C shows a result 730 of rendering a 3D scene generated by a neural network model trained by the alternative of fixed-view sampling.

FIG. 7D shows a result 740 of rendering a 3D scene generated by a neural network model trained by gradual view sampling.

When using the neural network model trained by the random view sampling (refer to FIG. 7A) or the neural network model trained by the random view sampling after initial training with the fixed camera view (refer to FIG. 7B), there may be a tendency of mode collapse in which generated scenes are similar to each other. In contrast, when using the neural network model trained by the alternative view sampling (refer to FIG. 7C) or the neural network model trained by the gradual view sampling (refer to FIG. 7D), there may be various variations between generated scenes and mode collapse may be less likely.

FIG. 8 illustrates an example training structure and operation of a neural network model according to one or more example embodiments. Referring to FIG. 8, a neural network model 800 according to an embodiment may include a generator (G) 810, an adaptive view sampler 830, a renderer 850, and a discriminator (D) 870. Respective operations of the generator G 810, the adaptive view sampler 830, the renderer 850, and the discriminator 870 are generally the same as ones of the generator 610, the adaptive view sampler 630, the renderer 650, and the discriminator 670 described with reference to FIG. 6, and thus following is description of operations other than those of the neural network model 600 of FIG. 6.

When a 2D image 809 corresponding to a single scene stored in a training DB is given along with a camera view V 808 corresponding to the image 809, the adaptive view sampler 830 may perform a perturbative view sampling method using the given camera view V 808 along with a 3D model 803 generated (based on a latent code 801) by the generator 810. The perturbative view sampling method may sample the given camera view V 808 while giving random changes (or perturbations) to a camera pose and a camera direction according to the given camera view V 808. Also, to add a change (or perturbation), the adaptive view sampler 830 may alternately or gradually add a change (or perturbation) after using a fixed camera view at an early stage of training, as with the gradual view sampling described above.

For example, when receiving the camera view V 808 corresponding to the real 2D image I 809, the adaptive view sampler 830 may randomly perturb a camera pose and/or a camera direction according to the camera view V 808 (corresponding to the real 2D image I 809) by the perturbative view sampling method and may output a sampled camera view V′ 805. The adaptive view sampler 830 may initially sample, a predetermined number of times, a fixed camera view according to a fixed camera pose corresponding to the 3D model 803. The adaptive view sampler 830 may perform sampling by using a camera view V′ 805 obtained by perturbing the camera view V 808 (corresponding to the real 2D image I 809) along with the fixed camera view, for each training iteration after a predetermined number of iterations are performed. The adaptive view sampler 830 may alternately sample the perturbed camera view V′ 805 and the fixed camera view, or may perform sampling by gradually expanding a camera view range from the fixed camera view to the perturbed camera view V′ 805, to allow the neural network model 800 to be trained with a sufficiently wide range of 3D information.

The adaptive view sampler 830 may sample the perturbed camera view V′ 805 based on the 3D model 803, the camera view 808 (corresponding to the real 2D image 809), and a current training iteration number 804, and transmit the sampled view to the renderer 850.

The renderer 850 may then generate (render) a 2D image I′ 807 corresponding to the 3D model 803 according to the perturbed camera view V′ 805. The discriminator 870 may output a degree of discrimination between the generated 2D image I′ 807 and the 2D image I 809 corresponding to a single scene previously stored in the training DB; the discrimination output may be in the form of REAL (or “1”) or FAKE (or “0”), for example.

In addition, since the camera view 808 (or a camera pose) corresponding to a ground truth for the real 2D image I 809 is given, training of the neural network model 800 may use a second loss (e.g., a pixel similarity loss) that is based on a degree of similarity between the camera view V 808 corresponding to the real 2D image I 809 and the camera view V′ 805 perturbed by the adaptive view sampler 830 and/or a third loss (e.g., a pixel similarity loss between a generated image and a real image) that is based on a degree of similarity between the generated image and the real image, in addition to a first loss that is based on a degree of discrimination between the 2D image I′ 807 generated by the renderer 850 and the real 2D image I 809 stored in the DB.

In addition, training of the neural network model 800 may also use a pixel similarity between (i) the stored real 2D image I 809 and (ii) the 2D image I′ 807 generated by the renderer 850 using the camera view V′ 805 (which is sampled without a perturbation to either the camera pose or the camera direction according to the camera view V 808).

The neural network model 800 may calculate the first loss that is based on the degree of discrimination between the 2D image 807 generated by the renderer 850 and the real 2D image 809, and may train the discriminator 870 based on the first loss. Also, the neural network model 800 may train the renderer 850 by the third loss described above.

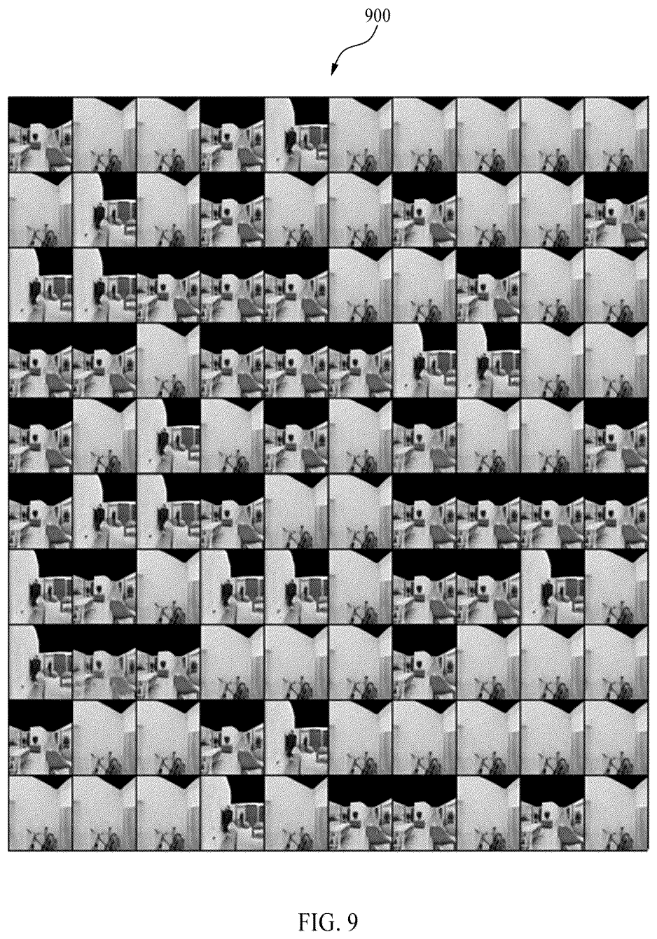

FIG. 9 illustrates example 2D images generated based on a fixed camera view of a neural network model according to one or more example embodiments. FIG. 9 shows a result 900 of rendering scenes generated using 100 latent codes by a camera view obtained by perturbing an input camera view, for a neural network model trained by a perturbative view sampling method according to an embodiment.

Using the neural network model trained by the perturbative view sampling method, there may be variations between generated scenes.

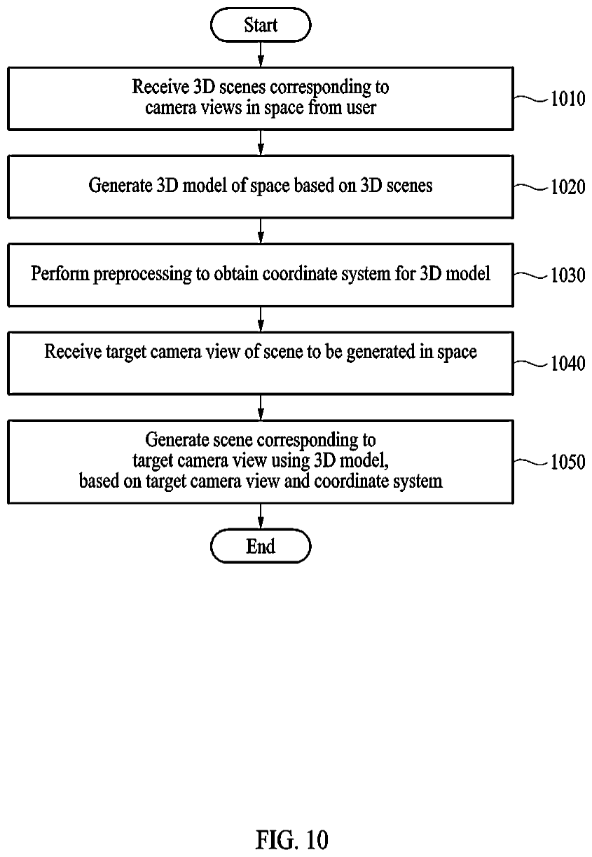

FIG. 10 illustrates an example method of generating a scene of a 3D model according to one or more example embodiments. Referring to FIG. 10, a device for generating a scene of a 3D model (hereinafter, simply referred to as a “generating device”) may generate a scene through operations 1010 to 1050.

In operation 1010, the generating device may receive 3D scenes corresponding to camera views in a specific space from a user device. The 3D scenes may correspond to 2D images obtained by capturing the specific space with an unspecified number of views.

In operation 1020, the generating device may generate a 3D model of the specific space based on the 3D scenes received in operation 1010.

In operation 1030, the generating device may perform preprocessing of obtaining a coordinate system for the 3D model generated in operation 1020. The generating device may generate a 3D scene corresponding to an initial camera view in the specific space. The generating device may set the coordinate system using the initial camera view, the 3D scenes, and the 3D model.

For example, the generating device may set the coordinate system according to at least one criterion among a coordinate system input from the user, a specific image among the 3D scenes, a floorplan portion of the specific space, a specific object included in the specific space, and bilateral symmetry of the specific space. In this example, the 3D scenes may not include information about a target camera view. The generating device may define a camera transform matrix that may set or correct the coordinate system according to the at least one criterion described above.

In operation 1040, the generating device may receive a target camera view of a scene to be generated in the specific space.

In operation 1050, the generating device may generate a scene corresponding to the target camera view using the 3D model based on the target camera view input in operation 1040 and the coordinate system obtained through the preprocessing process in operation 1030.

FIG. 11 illustrates an example inference structure and operation of a neural network model included in a generating device according to one or more example embodiments.

Referring to FIG. 11, a generating device 1100 according to an example embodiment may perform a preprocessing process 1160 and an inference process 1180. The generating device 1100 may include a generator 1110, a renderer 1130, and a coordinate system setter 1150. The coordinate system setter 1150 may be used in the preprocessing process 1160 and may not be used thereafter in the inference process 1180.

In the preprocessing process 1160, the generating device 1100 may generate a 3D model 1103 by inputting a latent code Z 1101 to the generator 1110. The generating device 1100 may apply, to the renderer 1130, the 3D model 1103 generated by the generator 1110 and an initial camera view V₀ 1105. The initial camera view V₀ 1105 may correspond to a camera view sampled by various view sampling methods described above. The renderer 1130 may generate or render an initial 2D image I₀′ 1107 which is a rendering of the 3D model 1103 as viewed from the initial camera view V₀ 1105.

A generator 1120 may learn a probability distribution represented by real data, and thus there may be no absolute coordinate of a 3D model 1104 generated by the generator 1120. The generating device 1100 may generate a scene corresponding to a target camera view in the inference process 1180 according to an absolute coordinate determined by defining a coordinate system using the 3D model 1103 generated by the latent code 1101 in the preprocessing process 1160.

The coordinate system setter 1150 may set or define a coordinate system by comparing the initial 2D image I₀′ 1107 to the 3D model 1103. For example, the coordinate system setter 1150 may set the coordinate system according to various criteria, for example, a selecting method based on a scene verified by a user, a selecting method based on a found coordinate system in which a specific image defined in advance appears, a method of defining an axis using bilateral symmetry, and an aligning method based on a floorplan portion. The coordinate system setter 1150 may define a camera transform matrix that corrects (or maps) the coordinate system according to the various criteria described above. The coordinate system setter 1150 may set reference points to determine where and how the rendered initial 2D image 1107 is located in the 3D space.

For example, it is assumed that the renderer 1130 renders the initial 2D image 1107 according to the initial camera view V₀ 1105 in the preprocessing process 1160. In this example, when the rendered initial 2D image 1107 is an image of viewing a wall opposite to a front door, although the user intended an image in a direction viewing the front door from the middle of a room, the generating device 1100 may set or correct the coordinate system or the camera transform matrix such that images subsequently rendered view in the direction of the front door.

In the inference process 1180, the generating device 1100 may seta camera view V 1106 according to the camera transform matrix defined by the coordinate system setter 1150, such that a 3D model 1104 operates in the previously set coordinate system.

As a result, the generating device 1100 may automatically set the coordinate system according to various criteria (e.g., a specific image, a specific object, bilateral symmetry, floorplan-based alignment, or the like) preferred by the user, in addition to a coordinate system input or selected by each user, and may thus improve usability and/or user convenience of the generating device 1100.

The coordinate system (or the camera transform matrix) output through the preprocessing process 1160 may be used during rendering by the renderer 1130 in the inference process 1180.

In the inference process 1180, the generating device 1100 may generate the 3D model 1104 corresponding to the 3D space by inputting a latent code Z 1102 to the generator 1120. The generating device 1100 may apply, to a renderer 1140, the 3D model 1104 and the coordinate system or the camera transform matrix output through the preprocessing process 1160. The renderer 1140 may then render the 3D model 1104 according to the coordinate system or the camera transform matrix, and the target camera view, that are obtained in the preprocessing process 1160 to generate a 2D image, and may thereby generate a scene of a 3D model corresponding to the target camera view in the specific space.

Alternatively, the generating device 1100 may receive a 3D scene of a specific space from a user, instead of the 3D model 1104 automatically generated by the generator 1120. In this case, the generating device 1100 may receive a target camera view corresponding to a 3D model of a scene the user desires to generate in the specific space. The generating device 1100 may render a 2D image according to the target camera view based on a coordinate system to generate a scene of a 3D model corresponding to the 3D scene received from the user.

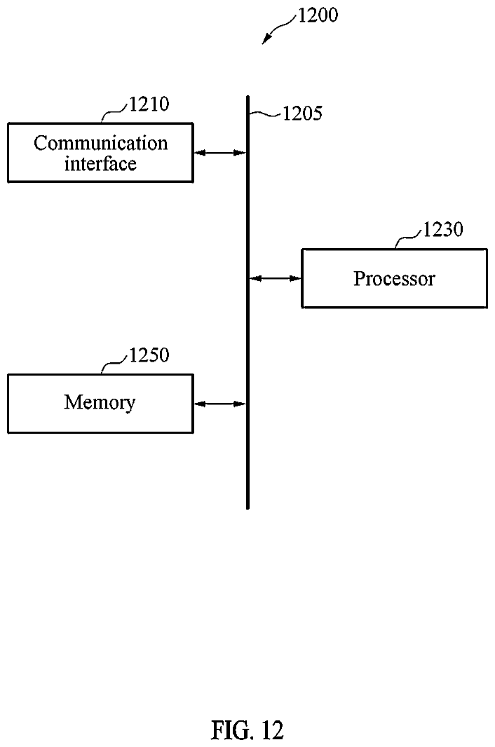

FIG. 12 illustrates an example generating device according to one or more example embodiments. Referring to FIG. 12, a generating device 1200 may include a communication interface 1210, a processor 1230, and a memory 1250. The communication interface 1210, the processor 1230, and the memory 1250 may be connected to each other through a communication bus 1205.

The communication interface 1210 may receive images of 3D scenes corresponding to camera views in a specific space from a user device. The communication interface 1210 may receive a target camera view of a scene to be generated in the specific space.

The processor 1230 may generate a 3D model of the specific space based on the images of the 3D scene. The processor 1230 may perform a preprocessing process of obtaining a coordinate system for the 3D model. The processor 1230 may generate a scene corresponding to the target camera view using the 3D model based on the target camera view and the coordinate system.

The processor 1230 may execute a program and control the generating device 1200, and code of the program to be executed by the processor 1230 may be stored in the memory 1250.

The memory 1250 may store the 3D model of the specific space generated by the processor 1230.

In addition, the memory 1250 may store at least one program and/or various pieces of information generated during processing of the processor 1230. For example, the memory 1250 may store an initial camera view used in a preprocessing process by the processor 1230 and/or an initial 2D image generated in the preprocessing process. The memory 1250 may also store an initial 2D image rendered in the preprocessing process and/or a coordinate system. However, examples are not necessarily limited thereto.

In addition, the memory 1250 may store various pieces of data and programs. The memory 1250 may include a volatile memory or a non-volatile memory. The memory 1250 may include a large-capacity storage medium such as a hard disk to store various pieces of data.

In addition, the processor 1230 may perform at least one of the methods described above with reference to FIGS. 1 through 11 or an operation or scheme corresponding to the at least one method. The processor 1230 may be, for example, a mobile application processor (AP), but is not necessarily limited thereto. Alternatively, the processor 1230 may be a hardware-implemented electronic device having a physically structured circuit to execute desired operations. The desired operations may include, for example, code or instructions included in a program. The hardware-implemented electronic device may include, for example, a microprocessor, a central processing unit (CPU), a graphics processing unit (GPU), a processor core, a multi-core processor, a multiprocessor, an application-specific integrated circuit (ASIC), a field-programmable gate array (FPGA), and a neural processing unit (NPU).

In view of the above, it may be appreciated that adaptive view sampling techniques described herein, in some implementations, may avoid the mode collapse problem that sometimes occurs in 3D-aware GANs, as described above. Although it may be desirable to obtain various 3D scenes along varying input latent codes (meaning not in a state of mode collapse), this can be difficult in 3D (rather than 2D) because of varying camera views. Even for a single identical scene, varying camera poses and directions can generate varying images in 2D, which may be used to train the GAN to generate a single scene in 3D, regardless of various input latent codes (z) (meaning a state of mode collapse), in particular, if no camera sampling technique is used (as seen in FIG. 7A) there may be, for example, 100 randomly sampled input latent codes (z), but all rendered using same fixed camera view. Even with varying latent codes, generated 3D scenes and their corresponding 2D images may be identical, and the trained model may be said to be mode collapsed. Various scenes may be generated in 3D with varying input latent codes, so correspondingly rendered 2D images should also have variety when they are rendered using a single fixed-identical camera view, as seen in FIGS. 7B-D. An adaptive view sampler, as performed with various techniques described herein, may use an identical camera view an earlier stage of training, and then, increase the camera pose variety (for further training) to cover the full 3D scene.

The computing apparatuses, the electronic devices, the processors, the memories, the image sensors/cameras, the displays, the information output systems and hardware, the storage devices, and other apparatuses, devices, units, modules, and components described herein with respect to FIGS. 1-12 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-12 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method of training a neural network model to generate a three-dimensional (3D) model of a scene, the method comprising:
generating the 3D model based on a latent code;
based on the 3D model, sampling a camera view comprising a camera position and a camera angle corresponding to the 3D model of the scene;
generating a two-dimensional (2D) image based on the 3D model and the sampled camera view; and
training the neural network model to, using the 3D model, generate a scene corresponding to the sampled camera view based on the generated 2D image and a real 2D image.

2. The method of claim 1, wherein the sampling of the camera view comprises:
sampling the camera view using a camera pose or a camera direction randomly determined based on a specific camera view distribution corresponding to the 3D model.

3. The method of claim 2, wherein the sampling of the camera view using the randomly determined camera pose or camera direction comprises:
determining the camera pose by a specific camera view distribution at a center of the 3D model; or
determining the camera direction by a random azimuth angle and by an altitude angle determined according to the specific distribution with respect to a horizontal plane.

4. The method of claim 2, wherein the sampling of the camera view using the randomly determined camera pose and camera direction comprises:
determining the camera pose by a specific camera view distribution based on a position separated a predetermined distance from a center of a specific object included in the 3D model; or
determining the camera direction by the specific camera view distribution in a direction toward the center of the specific object.

5. The method of claim 2, wherein the sampling of the camera view comprises:
selecting the camera view based on determining whether the sampled camera view is inside an object included in the 3D model.

6. The method of claim 2, wherein the specific camera-view distribution comprises either a Gaussian distribution or a uniform distribution.

7. The method of claim 1, wherein the sampling of the camera view comprises:
initially sampling, for a predetermined number of times, a fixed camera view that is based on a fixed camera pose corresponding to the 3D model; and
for each training iteration after a lapse of a predetermined number of times, sampling the camera view using both the fixed camera view and a random camera view that is based on a camera pose randomly determined based on a specific camera view distribution corresponding to the 3D model.

8. The method of claim 7, wherein the sampling of the camera view using both the fixed camera view and the random camera view comprises either:
alternately sampling the fixed camera view and the random camera view; or
sampling the camera view while gradually expanding a range of the camera view from the fixed camera view to the random camera view.

9. The method of claim 7, wherein the generating of the 2D image comprises:
generating first patches including a portion of the 2D image corresponding to the 3D model according to the camera view, and
wherein the training of the neural network model comprises:
training a discriminator of the neural network model to discriminate between the generated 2D image and the real 2D image based on a degree of discrimination between the first patches and second patches comprising respective portions of the real 2D image.

10. The method of claim 1, further comprising:
receiving a camera view corresponding to the real 2D image,
wherein the sampling of the camera view comprises:
sampling the camera view by randomly perturbing at least one of a camera position or a camera direction according to the camera view corresponding to the real 2D image.

11. The method of claim 10, wherein the sampling of the camera view comprises:
initially sampling, a predetermined number of times, a fixed camera view that is based on a fixed camera pose corresponding to the 3D model; and
for each training iteration after a lapse of a predetermined number of times, sampling the camera view using both the fixed camera view and the perturbed camera view corresponding to the real 2D image.

12. The method of claim 10, wherein the training of the neural network model comprises:
calculating a first loss based on a degree of discrimination between the generated 2D image and the real 2D image;
calculating a second loss based on a degree of similarity between the camera view corresponding to the real 2D image and the perturbed camera view; and
training the neural network model to generate a scene of the 3D model corresponding to the perturbed camera view based on the first loss and/or the second loss.

13. The method of claim 1, wherein the training of the neural network model comprises:
training a generator of the neural network model to generate a scene corresponding to the sampled camera view, using a third loss that is based on a degree of similarity between the generated 2D image and the real 2D image; and
training a discriminator of the neural network model to discriminate between the generated 2D image and the real 2D image, using a first loss that is based on a degree of discrimination between the generated 2D image and the real 2D image.

14. The method of claim 1, wherein the scene of the 3D model includes at least one of a still image or a moving image.

15. A method of generating an image of a three-dimensional (3D) model, the method comprising:
receiving images of a 3D scene respectively corresponding to camera views in a physical space;
generating a 3D model of the specific space based on the images of the 3D scene;
obtaining a coordinate system for the 3D model;
receiving a target camera view of an image to be generated of the physical space; and
generating the image of the physical space using the 3D model based on the target camera view and the coordinate system.

16. The method of claim 15, wherein the obtaining the coordinate system comprises:
generating a 3D model corresponding to an initial camera view in the specific space; and
setting the coordinate system using the initial camera view, the 3D scenes, and the 3D model corresponding to the initial camera view.

17. The method of claim 15, wherein the setting of the coordinate system comprises:
setting the coordinate system based on at least one criterion among: a coordinate system input by the user, a specific image among the 3D scenes, a floorplan portion of the specific space, a specific object included in the specific space, and bilateral symmetry of the specific space.

18. The method of claim 17, wherein the setting of the coordinate system further comprises:
defining a camera transform matrix that sets the coordinate system according to the at least one criterion.

19. A non-transitory computer-readable storage medium storing instructions that, when executed by a processor, cause the processor to perform the method of claim 1.

20. A device comprising:
memory storing images of a three-dimensional (3D) scene respectively corresponding to camera views in a physical space and storing a target camera view for an image of the physical space to be generated; and
a processor configured to generate a 3D model of the physical space based on the images of the 3D scene, perform a process of obtaining a coordinate system for the 3D model, and generate an image corresponding to the target camera view using the 3D model based on the target camera view and the coordinate system.
